(19) United States
(12) Patent Application Publication
(10) Pub. No.: US 2026/0115762 A1
(43) Pub. Date: Apr. 30, 2026

(54) MULTI-CHANNEL VIBRATOR AND ULTRASONIC DEVICE INCLUDING THE SAME

(71) Applicant: LG ELECTRONICS INC., Seoul (KR)

(72) Inventors: Sungho HONG, Seoul (KR); Hoseong SONG, Seoul (KR); Gueisam LIM, Seoul (KR); Inhwan CHOI, Seoul (KR); Nayoung KIM, Seoul (KR)

(73) Assignee: LG ELECTRONICS INC., Seoul (KR)

(21) Appl. No.: 19/088,225

(22) Filed: Mar. 24, 2025

(30) Foreign Application Priority Data
Oct. 28, 2024 (WO) PCT/KR2024/016551

(51) Int. Cl. B06B 1/02

(52) U.S. Cl. CPC B06B 1/02; B06B 2201/76

(57) ABSTRACT

A multi-channel vibrator for generating ultrasonic waves, can include a plurality of electrode channels located on one surface of the multi-channel vibrator, each electrode channel being spaced apart from each other. The plurality of electrode channels have different diameters from each other, and have one same center portion. Each of the plurality of electrode channels includes a current connection part connecting to one end of a wire for inputting an electric signal to a corresponding one of the electrode channels. Further, at least one of the plurality of electrode channels includes an extension having a portion extending to an outer side of the multi-channel vibrator and having the current connection part located on the extension.

### CROSS-REFERENCE TO RELATED APPLICATION

Pursuant to 35 U.S.C. § 119 (a), this application claims the benefit of earlier filing date and right of priority to International Application No. PCT/KR2024/016551, filed on Oct. 28, 2024, the contents of which are hereby incorporated by reference herein in their entirety.

### BACKGROUND OF THE DISCLOSURE

### Field of the Disclosure

The present disclosure relates to a multi-channel vibrator and an ultrasonic device including the same, and more specifically, to a multi-channel vibrator with an extension capable of facilitating wire connection to an electrode channel with a narrow area.

### Discussion of the Related Art

As interest in appearance increases day by day, cases of taking care of skin on a regular basis through a dermatology or a skin care shop as well as cosmetics are increasing. However, visiting a dermatology or a skin care shop to receive skin care is quite expensive and may put an economic burden on consumers. In order to solve this problem, self-skin care devices capable of facilitating skin care have recently appeared.

In the past, skin care devices that can be carried by individuals were rarely distributed, but portable skin care devices are being commercialized as wireless communication advances and parts can be miniaturized.

Such skin care devices may be implemented in various ways, and among them, devices using ultrasonic waves are receiving attention. Ultrasonic waves may stimulate the activity of skin cells by giving the skin a minute stimulus, thereby resulting in skin improvement effects such as wrinkle improvement, whitening, and the like.

It is possible to maximize the performance of cosmetics by assisting in the absorption of the cosmetics applied to the skin through the ultrasonic vibration. Furthermore, the ultrasonic waves may massage the skin to relax the muscles and increase skin elasticity.

An ultrasonic vibrator, which is one of the core components of an ultrasonic device, is designed to emit ultrasonic waves through a channel and focus the ultrasonic waves on a desired location. In addition, a multi-channel ultrasonic vibrator generates ultrasonic waves independently in each channel and may increase the concentration of ultrasonic waves by adjusting the levels of the main lobe and the side lobe, thereby enabling more sophisticated skin care.

However, since the multi-channel ultrasonic vibrator of the related art has a structure in which the width of a channel gets narrower toward the outside, there was a problem that it became difficult to perform wire connection.

In particular, disadvantages such as poor electric signal transmission or increased complexity during a manufacturing process occurred in the process of connecting wires to narrow electrodes.

To solve these problems, a new structure of multi-channel ultrasonic vibrator that provides more efficient wire connection and stable ultrasonic performance is required.

### SUMMARY OF THE DISCLOSURE

In order to solve the above-described problem, one object of the present disclosure is to provide a multi-channel vibrator having an extension capable of facilitating wire connection to an electrode channel.

Another object of the present disclosure is to provide a multi-channel vibrator capable of directly connecting to a PCB.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the disclosure will be set forth in the disclosure herein as well as the accompanying drawings. Such aspects may also be appreciated by those skilled in the art based on the disclosure herein.

In one technical aspect of the present disclosure, provides is a vibrator in a gentle dome shape for generating ultrasonic waves, the vibrator including a plurality of ring-shaped electrode channels located on one surface of the vibrator and spaced apart from each other due to different diameters while having the substantially same center with an axis of the gentle dome shape, wherein each of a plurality of the electrode channels has a current connection part connecting to one end of a wire for inputting an electric signal to each of the electrode channels and wherein at least one of a plurality of the electrode channels comprises an extension having a predetermined portion extending to an outer side of the vibrator and having the current connection part located thereat.

A plurality of the electrode channels may be substantially equal to each other.

A width of the extension may be greater than a channel width of the at least one electrode channel.

The at least one electrode channel may include an electrode channel located on a relatively outer side among a plurality of the electrode channels.

The extension may have a shape extending in a first direction all.

A hole perforated in the center around the axis may be further included.

A plurality of the electrode channels may further include a circular electrode channel located on one surface of the vibrator at the center around the axis.

Each of a plurality of the electrode channels may have the extension.

The extension may include a protruding extension extending further outward from an outer side of the vibrator and having the current connection part located thereat.

The protruding extension may protrude in a direction where the vibrator and a circuit board are in contact with each other and the current connection part may be electrically connected to the circuit board in a manner of substantially coming in contact with the circuit board.

Each of a plurality of the electrode channels may move a vibration focus of the ultrasonic waves by receiving an input of a different electric signal.

In one technical aspect of the present disclosure, provides is an ultrasonic device, including a body including a grip unit gripped by a user and a head unit located at an end portion of the grip unit, an ultrasonic generation unit located at an end portion of the head unit, a vibrator providing vibration to the ultrasonic generation unit, and a controller controlling the vibrator by supplying current to the vibrator, wherein the vibrator has a gentle dome shape, wherein the vibrator comprises a plurality of ring-shaped electrode channels located on one surface of the vibrator and spaced apart from each other due to different diameters while having the substantially same center with an axis of the gentle dome shape, wherein each of a plurality of the electrode channels has a current connection part connecting to one end of a wire for inputting an electric signal to each of the electrode channels, and wherein at least one of a plurality of the electrode channels comprises an extension having a predetermined portion extending to an outer side of the vibrator and having the current connection part located thereat.

A plurality of the electrode channels may be substantially equal to each other.

A width of the extension may be greater than a channel width of the at least one electrode channel.

The at least one electrode channel may include an electrode channel located on a relatively outer side among a plurality of the electrode channels.

The extension may have a shape extending in a first direction all.

A hole perforated in the center around the axis may be further included.

A plurality of the electrode channels may further include a circular electrode channel located on one surface of the vibrator at the center around the axis.

Each of a plurality of the electrode channels may have the extension.

The extension may include a protruding extension extending further outward from an outer side of the vibrator and having the current connection part located thereat.

The protruding extension may protrude in a direction where the vibrator and a circuit board are in contact with each other and the current connection part may be electrically connected to the circuit board in a manner of substantially coming in contact with the circuit board.

Each of a plurality of the electrode channels may move a vibration focus of the ultrasonic waves by receiving an input of a different electric signal.

According to an embodiment of the present disclosure, by simplifying an input electric signal, it is possible to stably provide an electric signal input while maintaining the efficiency of a focus variable ultrasonic vibrator.

In addition, according to an embodiment of the present disclosure, it is possible to simplify the connection process of wires and connectors during a manufacturing process by securing an area for a current connection part.

In addition, it is possible to reduce a product defect rate by reducing the complexity of a manufacturing process and improving the durability of a connection part.

In addition, by protruding a current connection part to maintain a ring shape of most of a channel, excellent product performance may be maintained without degrading the existing ultrasonic performance.

Further scope of applicability of the present disclosure will become apparent from the detailed description below. However, since various changes and modifications within the spirit and scope of the present disclosure may be clearly understood by those skilled in the art, specific embodiments such as detailed descriptions and embodiments of the present disclosure should be understood as being given only as examples.

### BRIEF DESCRIPTION OF THE DRAWINGS

FIG. 1 is a diagram illustrating an ultrasonic device according to an embodiment of the present disclosure.

FIG. 2 is a diagram for explaining focus variation of a vibrator according to an embodiment of the present disclosure.

FIG. 3 is a diagram for explaining a type of a vibrator according to an embodiment of the present disclosure.

FIG. 4 is a diagram for explaining the configuration of a vibrator according to an embodiment of the present disclosure.

FIG. 5 is a diagram illustrating an embodiment in which the vibrator of FIG. 4 is connected to an electric wire.

FIG. 6 is a diagram for explaining a vibrator according to another embodiment of the present disclosure.

FIG. 7 is a diagram for explaining a vibrator according to further embodiment of the present disclosure.

FIG. 8 is a diagram for explaining a vibrator according to another further embodiment of the present disclosure.

FIG. 9 is a diagram illustrating an embodiment in which the vibrator of FIG. 8 is connected to a PCB.

### DETAILED DESCRIPTION OF THE DISCLOSURE

Description will now be given in detail according to embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

A device for skin care is implemented in various ways. The skin receives a minute stimulus to change the activity of cells and the like, and thus may bring about skin improvement effects such as wrinkle improvement, whitening, etc.

Representative forms include non-invasive methods that provide electrical stimulation to the skin and invasive methods that provide physical stimulation.

Previously, individual portable devices were not distributed, but recently, portable care devices have been widely commercialized as wireless communication development and parts miniaturization become possible.

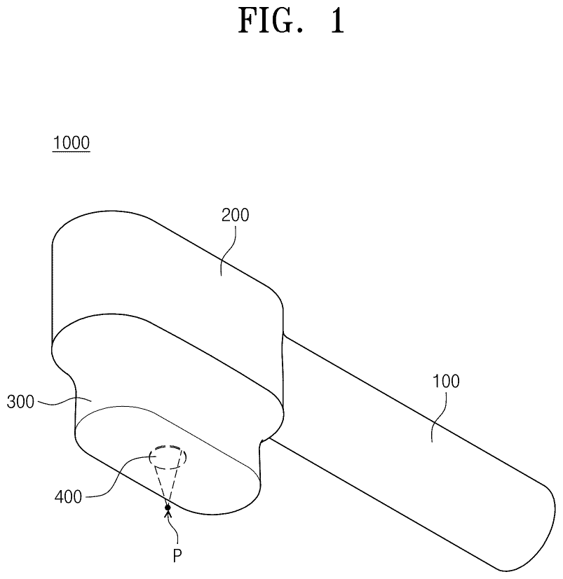

FIG. 1 is a diagram illustrating an ultrasonic device 1000 according to an embodiment of the present disclosure. As an embodiment, an ultrasonic skin care device acting on a deep portion and a surface of the human skin may be included.

The ultrasonic device 1000 of the present disclosure may include a grip unit 100 held by a user by a hand, a head unit 200 located at an end portion of the grip unit 100, an ultrasonic generation unit 300 located at an end portion of the head unit 200, and a vibrator 400 that provides vibration to generate ultrasonic waves.

The grip unit 100 may include a space for accommodating a battery as a power supply unit and a printed circuit board as a control unit, and a manipulation unit for turning on/off power and operating power may be provided at an outer side thereof. A display unit for displaying a current operation state may be further included. The display unit may include one of a type of simply displaying a color of lamp or a type of displaying text or symbol like liquid crystals.

The grip unit 100 may include a power connection unit for connecting an external power. The power connection unit may adopt a method of supplying power constantly in case of absence of battery, and serves to charge a battery in case of being provided with the battery. For charging, power may be supplied by connecting a charger supplied with external power to a terminal, or charging may be performed by a wireless charging method.

The grip unit 100 and the head unit 200 may form an angle between 90° and 180° for convenience when a user applies a force so that the ultrasonic generation unit 300 touches a face.

The ultrasonic generation unit 300 may include a vibrator 400, a wire connected to the vibrator 400, and a housing in which a connector or a circuit board are mounted inside. It may also form a portion that touches a user's face.

Hereinafter, a direction in which a focal point P exists based on the vibrator 400 will be referred to a lower side, and an opposite direction will be referred to an upper side.

The vibrator 400 may vibrate by receiving an input of an electric signal to generate ultrasonic waves. The vibrator 400 may be located close to the lower side of the ultrasonic generation unit 300. Accordingly, the focal point P on which the ultrasonic waves generated by the vibrator 400 are concentrated may be located outside the ultrasonic generation unit 300. By adjusting the position where the focal point P is located outside the ultrasonic generation unit 300, as described above, subcutaneous tissue or fascia that is a lower portion of the skin in contact with the ultrasonic generation unit 300 may be stimulated.

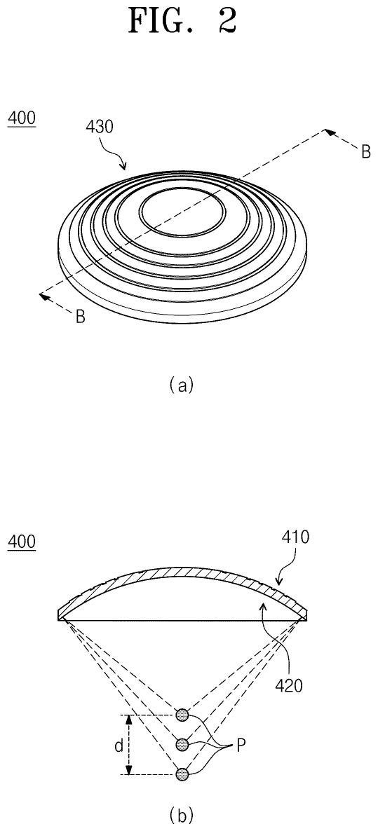

Referring to FIG. 1, the vibrator 400 may have a gentle dome shape. Hereinafter, the vibrator 400 will be described in detail with reference to FIG. 2 as well.

FIG. 2 is a diagram for explaining the variation of the focus of the vibrator 400 according to one embodiment of the present disclosure. FIG. 2(a) is a diagram illustrating a perspective view of a gentle dome-shaped vibrator from a top side, and FIG. 2(b) is a diagram illustrating a schematic view of a B-B cross section in FIG. 2(a), and is a diagram for explaining the focus variation.

A vibrator according to an embodiment of the present disclosure may be a focus variable ultrasonic vibrator. In general, an ultrasonic vibrator is a High Intensity Focused Ultrasound (HIFU) vibrator, which may be formed in a gentle dome shape, and has a shape in which electrodes are positioned overall on an upper surface 410 that may be regarded as an outer surface of the gentle dome shape or a lower surface 420 that may be regarded as an inner surface of the dome shape.

When an ultrasonic wave is generated by inputting an electric signal to an electrode in such a configuration, a focus of the ultrasonic wave is affected by the dome shape and is characterized in being fixed at a specific point.

On the other hand, referring to FIG. 2(a), in the focus variable ultrasonic vibrator according to an embodiment of the present disclosure, an electrode of an upper surface 410 or a lower surface 420 may be divided into a plurality of ring-shaped electrode channels 430. That is, a plurality of ring-shaped electrode channels spaced apart from each other due to different diameters despite the substantially same axis and center of the gentle dome shape may be included.

In FIG. 2(a), an example in which the electrode of the upper surface 410 is divided is shown, but the present disclosure is not limited thereto, and a plurality of the electrode channels 430 constituting the electrode may be located only on one of the upper surface 410 or the lower surface 420. In addition, FIG. 2(a) shows an example of being divided into 7 regions, but the number of electrode channels is not limited thereto, and may be smaller or larger.

By including a plurality of electrode channels as described above, a position of a focal point P may be adjusted by adjusting an electric signal inputted to each channel. Hereinafter, it will be further described with reference to FIG. 2(b).

FIG. 2(b) illustrates a cross-section of the vibrator 400, showing positions of the upper surface 410 and the lower surface 420 of the vibrator. The vibrator has a dome-shaped structure, and this structure may affect a focal position of ultrasonic waves generated from the vibrator.

The focal point P represents a location where ultrasonic waves generated by the vibrator gather. The focal point is located in a direction in which a curved surface of the vibrator faces inward, and this location may be affected by a curvature of the vibrator and an inputted electric signal.

The vibrator according to an embodiment of the present disclosure is a focus variable ultrasonic vibrator, and may move a focus of ultrasonic waves by inputting different electric signals to a plurality of the electrode channels 430, respectively. Referring to FIG. 2(b), the focal point P may move in a vertical direction d, which may be adjusted according to an electric signal inputted to each of a plurality of electrode channels 430.

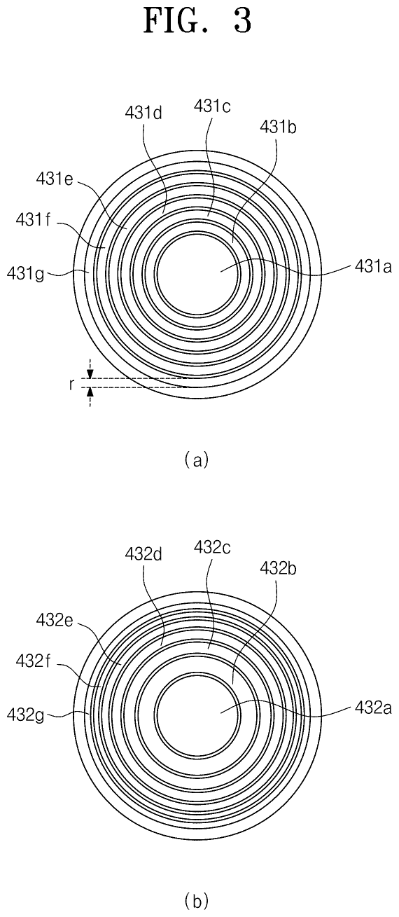

FIG. 3 is a diagram for explaining a type of vibrator according to an embodiment of the present disclosure. FIG. 3(a) shows a same-width electrode channel having the same width of each channel, and FIG. 3(b) shows a same-area electrode channel having the same area of each channel.

As described above, one electrode of a vibrator may have a plurality of electrode channels. In order to generate ultrasonic waves, an electric signal having a waveform such as a sine wave, a square wave, or the like should be inputted to each electrode channel. In this case, in order to adjust the energy generated in each channel to a similar level, it may be required that the width of each channel is the same or the area of each channel is the same.

Referring to FIG. 3(a), in the case of the same-width electrode channel, second to seventh channels 431b to 431g except for a first channel 431a located at the center may have a ring shape having the same width r. In this case, the area occupied by each channel becomes different, and the outer channel occupies a larger area. Therefore, in order to focus the entire ultrasonic waves generated by the vibrator to a focal point, the amplitude of the waveform of the electric signal inputted to each channel should be set differently.

Therefore, in the case of the same-width electrode channels, the amplitude of an input signal should be set differently for each channel, so there may be difficulties in working to operate the vibrator.

On the other hand, since the same-area electrode channels 432a to 432g have the same area of all channels including a first channel 432a at the center, even if the amplitude of the waveform of an electric signal inputted to each channel is set equally, a focal point of ultrasonic waves generated for each channel may be concentrated to one point.

However, in such a case, in order to equalize the area, it is characterized in that the width of the channel becomes narrower toward the outer channel. Therefore, in the case of the fifth to seventh electrode channels 431e to 431g located outside, there is a disadvantage that connection is difficult because the width is narrower than the thickness of the wire connected to the channel or the area occupied by soldering for connection.

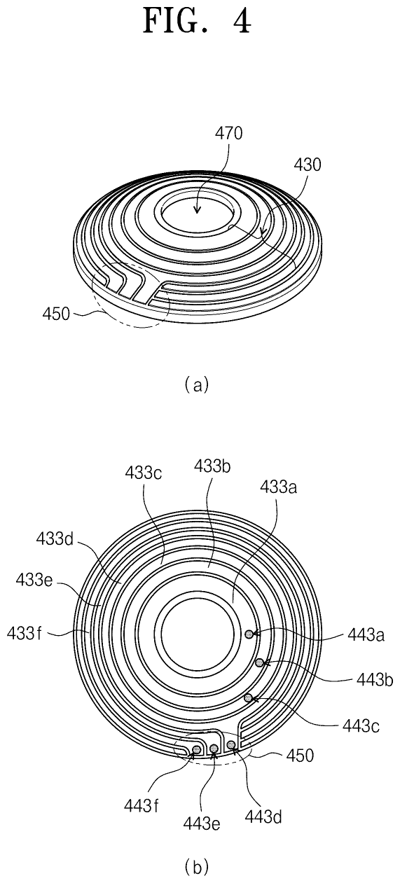

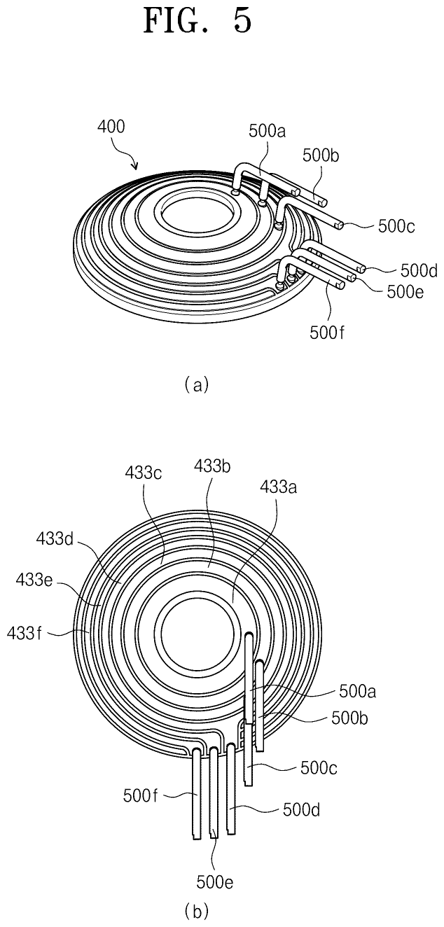

Hereinafter, a vibrator according to an embodiment (first embodiment) of the present disclosure will be described with reference to FIGS. 4 and 5. FIG. 4 is a diagram for explaining the configuration of a vibrator according to an embodiment of the present disclosure. FIG. 4(a) is a perspective diagram illustrating the vibrator, and FIG. 4(b) is a layout of the vibrator. FIG. 5 is a diagram illustrating an embodiment in which the vibrator of FIG. 4 is connected to an electric wire. FIG. 5(a) is a perspective diagram illustrating a vibrator to which electric wires are connected, and FIG. 5(b) is a layout of the vibrator to which electric wires are connected.

Referring to FIGS. 4 and 5, a vibrator according to a first embodiment of the present disclosure may additionally include a hole 470. As described above, the vibrator has a gentle dome shape, and the hole 470 may further include a hole vertically passing through the center, i.e., a ceiling portion of the vibrator vertically centering around an axis of the dome shape. The hole 470 may serve as an idle space for other components or devices.

The vibrator 400 may include a plurality of electrode channels 430 in ring shapes forming concentric circles around the hole. That is, a plurality of the electrode channels may be positioned in ring shapes surrounding the hole with different diameters, respectively. Also, the electrode channels are area-same electrode channels, and may decrease gradually in width toward the outside.

In this case, at least one of a plurality of the electrode channels may include an extension 450. The extension 450 is a part formed by extending a predetermined part from an originally ring-shaped electrode channel to the outside of the vibrator, and provides a space for current connection parts 443a to 443f.

The current connection parts 443a to 443f are, for example, portions in which a wire or connector is connected to transmit an electric signal to the electrode channel 430. A wire is a configuration for transmitting an electric signal to a vibrator, and may be a concept including other components capable of performing such a role.

A wire or connector is merely an example of a configuration for transmitting an electric signal. Hereinafter, in the present specification, the following description is made on the assumption that a wire is connected.

A wire is generally fixed to a current connection part by soldering, and an electrical connection between the wire and the current connection parts 443a to 443f is made through soldering. In this process, the soldered wire transfers current to an electrode so that the ultrasonic vibrator may operate. Soldering is just one example and the connection may be made in various ways.

In this case, the current connection parts 443a to 443f may require a predetermined area or more to be stably connected to the wire. Therefore, in order to secure such a necessary area, if an outer electrode among a plurality of electrode channels fails to have a sufficient width, the current connection part may be provided with the extension 450.

FIG. 4 illustrates a case in which first to third channels 433a to 433c among a plurality of electrode channels do not have an extension 450 but have complete ring shapes. This is because the channel located inside may have a sufficient width to secure current connection parts 443a to 443c.

For example, each of the first to third channels 443a to 433a to 433c shown in FIG. 4(b) has a sufficient width, and thus the current connection parts 443a to 443c may be positioned at any positions that may be connected to the channels, respectively. The positions of the current connection parts 443a to 443c shown in FIG. 4(b) are only examples and are not limited thereto.

On the other hand, in the case of a channel located at an outer position, for example, in the case of fourth to sixth channels 433d to 433f of FIG. 4(b), ring portions may not have sufficient widths for positioning the current connection parts 443d to 443f, respectively. Accordingly, the area of the current connection part may be stably secured by providing an extension 450 partially extending outward and positioning the current connection parts 443d to 443f in the extension.

For this role, the extension 450 may have a width wider than a width of an electrode channel having the extension. In this case, it is enough for the width of the extension to secure the area of the current connection part. Some channels may not be able to form perfect ring shapes due to the formation of the extension, but the effect on the ultrasonic performance is insignificant, and thus the performance of the vibrator is not deteriorated. Therefore, a current connection may be stably provided without significantly affecting ultrasonic performance due to the formation of the extension.

In addition, since the extension is highly necessary when the width of the ring portion is narrow, an electrode channel located in the outer area may be mainly provided as shown in FIG. 4.

In addition, as shown in FIGS. 4 and 5, in the case of electrode channels having the extension, all of them may have a shape extending in a first direction (downward direction in the drawing). By extending in a manner of gathering in the same direction, the wire connection process and maintenance may be facilitated (see FIG. 5).

Referring to FIGS. 4 and 5 together, wires 500a to 500f may be connected to the current connection parts 443a to 443f. In this case, one wire is connected to each electrode channel, and each wire may input an electric signal for generating ultrasonic waves to each electrode channel. In this case, the inputted electric signal may be the same or different.

In this way, the vibrator according to an embodiment of the present disclosure may stably connect the wire by having the extension, and thus may stably provide an input of an electric signal. In addition, a connection step may be simplified during a manufacturing process, and an occurrence rate of defective products such as detached wires may be significantly reduced by securing a sufficient attachment area.

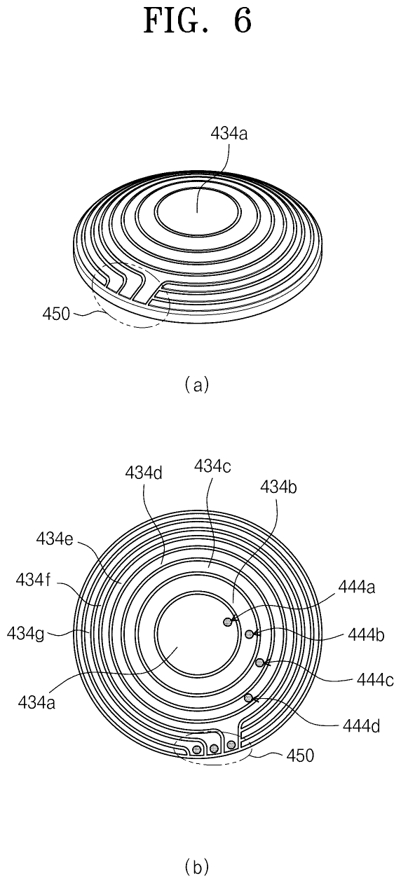

FIG. 6 is a diagram for explaining a vibrator according to another embodiment (second embodiment) of the present disclosure. FIG. 6(a) is a perspective view of the vibrator, and FIG. 6(b) is a plan view of the vibrator.

A vibrator according to a second embodiment of the present disclosure may have a complete dome shape. Referring to FIG. 6, the vibrator according to the second embodiment may further include a circular electrode channel, e.g., a first electrode channel 434a, positioned on one surface of the vibrator in a manner of being located at the center around the axis.

In this case, each of first to seventh electrode channels 434a to 434g including the first electrode channel at the center may have the same area.

The vibrator according to the second embodiment may also include an extension 450 as described above with reference to FIGS. 4 and 5. The extension 450 is described in detail with reference to FIGS. 4 and 5, and thus a description thereof will be omitted.

Referring to FIG. 6(b), since the first to fourth electrode channels 434a to 434d positioned on inner side do not have the extension but have sufficiently large widths, current connection parts 444a to 444d may be positioned at the electrode channels so as to be directly connected to electric wires, respectively.

On the other hand, in the case of the fifth to seventh electrode channels 434e to 434g positioned on the outer side, since the current connection part has difficulty in being positioned due to a narrow width thereof, current connection parts 444c to 444g may be positioned in a manner of being provided with an extension.

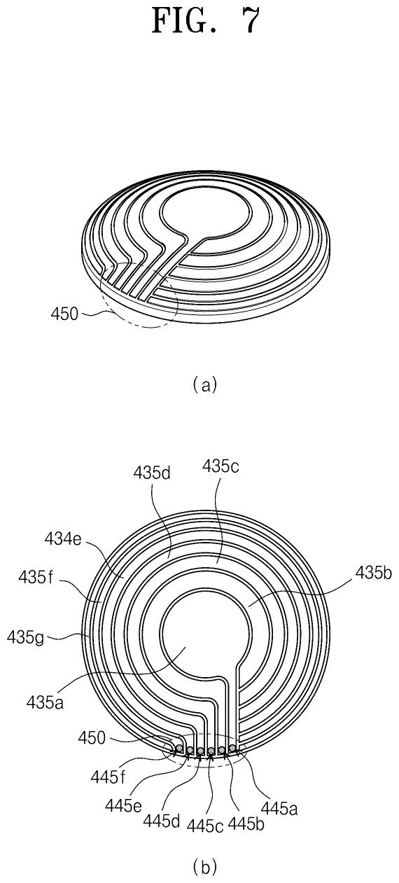

FIG. 7 is a diagram for explaining a vibrator according to another embodiment (third embodiment) of the present disclosure. FIG. 7(a) is a perspective view of a vibrator, and FIG. 7(b) is a plan view of the vibrator.

A vibrator according to a third embodiment may have a shape in which each of electrode channels 435a to 435f has an extension 450. The extension 450 is described in detail in FIGS. 4 and 5, and thus a description thereof is omitted.

When all of the electrode channels have the extension 450, all of the extensions may be positioned in one direction, and as a result, they may gather in a manner of being overlapped as shown in the drawing.

Such disposition also allows current connection parts 445a to 445f to be located adjacent to each other, thereby facilitating a wire connection process or management.

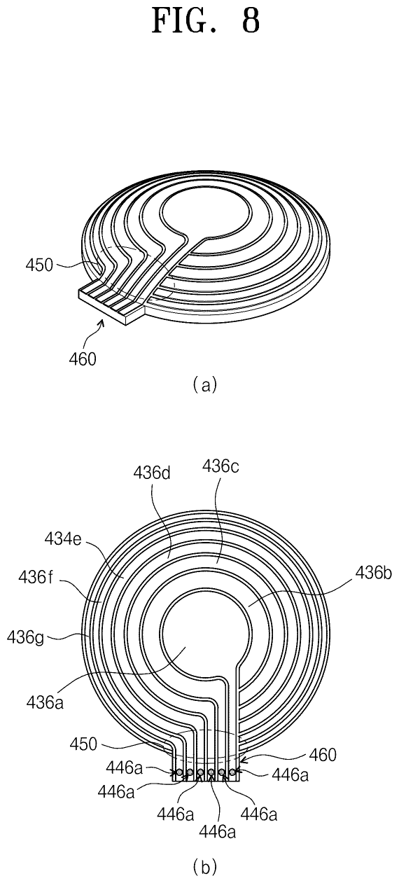

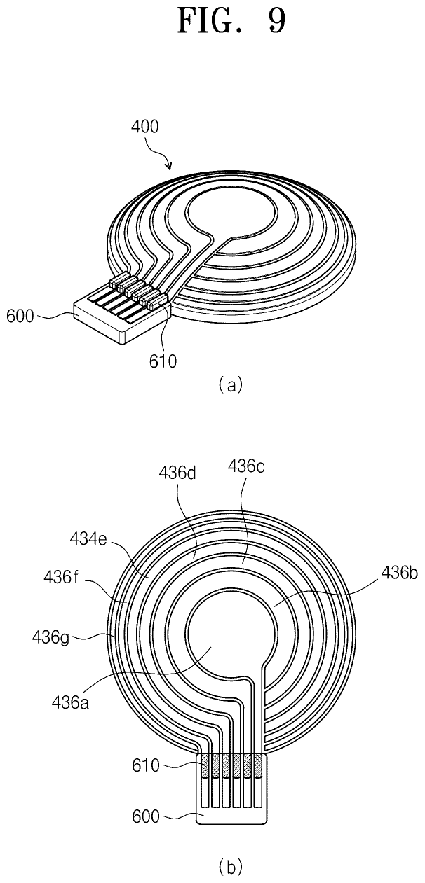

Hereinafter, another embodiment (fourth embodiment) of the present disclosure will be described with reference to FIGS. 8 and 9.

FIG. 8 is a diagram for explaining a vibrator according to further embodiment of the present disclosure. FIG. 8(a) is a perspective view of a vibrator, and FIG. 8(b) is a plan view of the vibrator. FIG. 9 is a diagram illustrating an embodiment in which the vibrator of FIG. 8 is connected to a PCB. FIG. 9(a) is a perspective view, and FIG. 9(b) is a plan view.

Referring to FIG. 8, in a vibrator according to a fourth embodiment, each of electrode channels 436a to 435f may include an extension 450 as in the third embodiment, and may further include a protruding extension 460 extending further outward from the outside of the vibrator in each extension and having the current connection part located thereat.

In other words, the expansion 450 of each electrode channel may include a protruding extension 460 extending in the same direction of the vibrator and protruding out of a dome shape, and current connection parts 446a to 446f may be located at the protruding extension 460.

Such a structure further facilitates wire connection, and it is also possible to directly connect a Printed Circuit Board (PCB) 600 to the protruding extension 460.

FIG. 9 is a diagram illustrating an embodiment in which the vibrator 400 described in FIG. 8 is connected to a PCB 600. FIG. 9(a) is a perspective view, and FIG. 9(b) is a plan view.

Referring to FIG. 9 together, a protruding extension 460 of a vibrator 400 is located close to a PCB 600, and accordingly, current connection parts 446a to 446f formed in the protruding extension may be directly connected to the circuit of the PCB. The connection with the PCB allows an electric signal to be stably transmitted through the current connection part, through which a signal is supplied to each electrode channel.

The current connection parts 446a to 446f may be electrically connected to the PCB through soldering or a connector 610. Soldering may facilitate the transmission of electric signals through direct connection between metals and may provide strong mechanical coupling. On the other hand, the connector provides a detachable connection between the PCB and the vibrator, thereby facilitating maintenance and replacement operations.

FIG. 9(b) illustrates in detail a state in which the protruding extension 460 connected to each of the electrode channels 436a to 436f contacts a circuit on the PCB. Through such a configuration, an electric signal is stably transmitted to each electrode channel, and an electrical input required for generating ultrasonic waves is made.

The current connection part is in direct contact with the PCB by using the protruding extension 460, thereby simplifying the circuit design and reducing instability possibly occurring in a wire connection process. Accordingly, it is possible to simplify a manufacturing process and improve product durability.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

What is claimed is:

1. A multi-channel vibrator for generating ultrasonic waves, the multi-channel vibrator comprising:
a plurality of electrode channels located on one surface of the multi-channel vibrator, each electrode channel being spaced apart from each other,
wherein the plurality of electrode channels have different diameters from each other, and have one same center portion,
wherein each of the plurality of electrode channels includes a current connection part connecting to one end of a wire for inputting an electric signal to a corresponding one of the electrode channels, and
wherein at least one of the plurality of electrode channels includes an extension having a portion extending to an outer side of the multi-channel vibrator and having the current connection part located on the extension.

2. The multi-channel vibrator of claim 1, wherein areas of the plurality of electrode channels are substantially equal to each other.

3. The multi-channel vibrator of claim 1, wherein a width of the extension is greater than a channel width of the at least one of the plurality of electrode channels.

4. The multi-channel vibrator of claim 1, wherein the at least one of the plurality of electrode channels is located on a relatively outer side of the multi-channel vibrator with respect to the plurality of electrode channels.

5. The multi-channel vibrator of claim 1, wherein the extension does not contact the center portion.

6. The multi-channel vibrator of claim 1, further comprising a hole perforated in the center portion.

7. The multi-channel vibrator of claim 1, wherein the plurality of electrode channels further comprise a circular electrode channel located on the one surface of the multi-channel vibrator at the center portion.

8. The multi-channel vibrator of claim 1, wherein each of the plurality of electrode channels includes the extension.

9. The multi-channel vibrator of claim 1, wherein the extension comprises a protruding extension extending further outward from the outer side of the multi-channel vibrator and having the current connection part located on the protruding extension.

10. The multi-channel vibrator of claim 9, further comprising:
a circuit board being in contact with the multi-channel vibrator,
wherein the protruding extension protrudes in a direction where the multi-channel vibrator and the circuit board are in contact with each other, and
wherein the current connection part contacts the circuit board and is electrically connected to the circuit board.

11. The multi-channel vibrator of claim 1, wherein each of the plurality of electrode channels is configured to move a vibration focus of the ultrasonic waves based on the electric signal.

12. An ultrasonic device, comprising:
a body including a grip configured to be gripped by a user and a head located at an end portion of the grip;
an ultrasonic generator located at an end portion of the head;
a vibrator configured to provide vibration to the ultrasonic generator, the vibrator including a plurality of electrode channels located on one surface of the vibrator, each electrode channel being spaced apart from each other; and
a controller configured to control the vibrator by supplying current to the vibrator,
wherein the plurality of electrode channels have different diameters from each other, and have one same center portion,
wherein each of the plurality of electrode channels includes a current connection part connecting to one end of a wire for inputting an electric signal to a corresponding one of the electrode channels, and
wherein at least one of the plurality of electrode channels includes an extension having a portion extending to an outer side of the vibrator and having the current connection part located on the extension.

13. The ultrasonic device of claim 12, wherein areas of the plurality of electrode channels are substantially equal to each other, and
wherein each of the plurality of electrode channels is configured to move a vibration focus of ultrasonic waves based on the electric signal.

14. The ultrasonic device of claim 12, wherein a width of the extension is greater than a channel width of the at least one of the plurality of electrode channels.

15. The ultrasonic device of claim 12, wherein the at least one of the plurality of electrode channels is located on an outer side of the vibrator with respect to the plurality of electrode channels.

16. The ultrasonic device of claim 12, wherein the vibrator has a dome shape.

17. The ultrasonic device of claim 12, further comprising a hole perforated in the center portion.

18. The ultrasonic device of claim 12, wherein the plurality of electrode channels further comprise a circular electrode channel located on the one surface of the vibrator at the center portion.

19. The ultrasonic device of claim 12, wherein each of the plurality of electrode channels includes the extension.

20. The ultrasonic device of claim 12, further comprising a circuit board being in contact with the vibrator,
wherein the extension comprises a protruding extension extending further outward from the outer side of the vibrator and having the current connection part located on the protruding extension,
wherein the protruding extension protrudes in a direction where the vibrator and the circuit board are in contact with each other, and
wherein the current connection part contacts the circuit board and is electrically connected to the circuit board.

21. A vibrator for generating ultrasonic waves, the vibrator comprising:
a plurality of electrode channels located on a dome shape of the vibrator, each electrode channel being located at a different height with respect to a vertical direction and each electrode channel having a different diameter with respect to a horizontal direction,
wherein at least one of the electrode channels includes a current connection part, the current connection part having one end configured to receive an electric signal and the current connection part having a varying vertical height on the vibrator.

22. The vibrator of claim 21, wherein a center portion of the vibrator includes a hole, and
wherein the hole is located at a center portion of the plurality of electrode channels.

23. The vibrator of claim 21, wherein a width between each of the current connection parts is the same.
